(19) United States
(12) Patent Application Publication
(10) Pub. No.: US 2007/0026917 A1
(43) Pub. Date: Feb. 1, 2007

(54) Interference interface for interaction between multimedia system and participant

(75) Inventor: Robert A. Daviau, Longmeadow, MA (US)

Correspondence Address: PERRY HOFFMAN & ASSOCIATES P.C., PO BOX 1649, DEERFIELD, IL, 60015, US

(73) Assignee: Hasbro, Inc.

(21) Appl. No.: 11/191,394

(22) Filed: Jul. 28, 2005

(51) Int. Cl. A63F 13/00

(52) U.S. Cl. 463/1; 463/30

(57) ABSTRACT

Interaction between a multimedia system in a multiplayer board game using a DVD player or a computer is disclosed in which participant players interact with the multimedia system through an input device in response to selections made through the display. An interference interface, for example a red reader lens, provides a unique type of interaction with the multimedia system generating concealed images on the display that only the interference interface is able to reveal, allowing the game to proceed by sending messages encoded in the concealed image to only the player with the interference interface at the time the image is displayed which allows a selected player to receive messages from the game system. Additionally, the interference interface also facilitates the player sending a message to the game by moving an encoded image under one of many selections available on the display. The display of the concealed image is generated by the multimedia system, viewed using the reader to receive the message, and the input device transmits the input selection. The multimedia system receives the inputted message, processes, and displays an output in response.

### BACKGROUND OF THE INVENTION

1. Field of the Invention

The present invention relates to an interference interface whereby a player participant may input and receive concealed information by way of a handheld reader or viewing media. More particularly, the invention relates to an interference interface for use with a video display and a lens for the purpose of viewing concealed indicia and for playing a multiplayer game linked to a multimedia system.

2. Description of the Related Art

Methods of concealing information have been employed through the use of interference interfaces in which an image becomes viewable through a filtering lens. Interference reader interfaces work using the color of the interface lens to filter out the associated color in the image. This occurs because in viewing the image through the interface, the background becomes the color of the interface and, therefore, any instance of that color in the image becomes indistinguishable from the background. The filtering interface works best when colors of the opposite spectrum are used in the concealed image. This creates high contrast between the colors such that when the interface is used and the lens color blends into the background of the image, the contrasting color becomes dominant and easily viewable. Interference interfaces have been used in the past to read concealed images on postcards, create 3D images on screens through lens of two different colors, or read words on playing cards of multiplayer games.

As multimedia technology has become more accessible to the public, game manufacturers have begun to incorporate traditional board games and the like with media for multimedia systems such as DVD video machines and televisions. One way of accomplishing participant interaction is by way of the multimedia system seeking answers to questions in audio or video form and having the participant players answer questions, then moving game pieces on a board in response. Players using a multimedia user interface indicate to the multimedia system that they are ready for a question. The system selects a question and plays the audio or video clip corresponding to the question selected. Players decide on an answer, indicate to the multimedia system that that are ready to see or hear the answer, and the system then plays an audio or video clip that reveals the answer. This interaction between multimedia system and traditional games makes the games more exciting to both younger generations who have become accustomed to interactive multimedia systems and to older generations who get to view the game in a new way.

In competitive multiplayer games, there has always been a need for a player to conceal information that he possesses from the other players. The concealing of a player's information enables him to have a competitive advantage over the other players in the game. Previous games have attempted to achieve the goal of confidentiality of information through the use of one-sided playing cards or rules limiting how a player may ask for information from others.

Sometimes games require the need to conceal information from players of the game. This may be particularly necessary if the purpose of the game is to solve a puzzle. Previous games have attempted to solve this problem by having the answer to the puzzle placed in an envelope. However, this is imperfect because once a player makes a guess and is wrong, he knows the right answer to the puzzle and can no longer participate in the game.

It would be desirable to incorporate interference reader technology into the growing multimedia interactive game market. It is not believed that a multimedia interactive game has used an interference interface to selectively read concealed images on a display for the purpose of inputting or receiving information. The invention described herein addresses this deficiency of the prior art.

### SUMMARY OF THE INVENTION

The present invention provides an interaction between a multimedia system in a multiplayer board game using a DVD player, in which participant players interact with the multimedia system through an input device in response to selections made through the display. A method for an interaction between a player and the game uses an interference interface for receiving private information from the game through the interference interface, and alternately inputting private information from the player to the game through the interference interface. A computer readable media is operable to provide a display routine for displaying the concealed image on a display viewable by a reader, and an input interface routine receives an input selection responsive to an input device and the concealed image being displayed on the display allowing the user to provide input selection.

The interference interface facilitates interaction with the multimedia system generating concealed images on the display that only the interference interface is able to reveal, allowing the game to proceed by sending messages encoded in the concealed image to only the player with the interference interface at the time the image is displayed which allows a selected player to receive messages from the game system. Additionally, the interference interface also facilitates the player sending a message to the game by moving an encoded image under one of many selections available on the display. The display of the concealed image is generated by the multimedia system, viewed using the reader to receive the message, and the input device transmits the input selection. The multimedia system receives the inputted message, processes, and displays an output in response.

### BRIEF DESCRIPTION OF THE DRAWINGS

The invention will now be more particularly described, by way of example, with reference to the accompanying drawings, novel features believed characteristic of the invention are set forth in the appended claims. The invention itself as well as the preferred mode of use, further objectives and advantages thereof, is best understood by reference to the following detailed description of the embodiments in conjunction with the accompanying drawings and Appendix, in which:

FIG. 1 illustrates an interference interface in accordance with a described embodiment of the present invention illustrating use of a Red Reader interface lens;

FIG. 2 shows the case selection menu displayed when the DVD disc is initially used with the DVD player;

FIG. 3 illustrates the case main menu that allows a player to select a multimedia option during his turn;

FIG. 4 illustrates a flow chart for the programming flow of a note selection from the case main menu;

FIG. 5 illustrates an example of a concealed number viewable through the Red Reader interface;

FIG. 6 illustrates a flow chart for the programming flow of the Final Accusation selection from the case main menu;

FIG. 7 illustrates an example of a concealed letter viewable through the Red Reader interface;

FIG. 8 illustrates an example of the character selection screen used in the Final Accusation process; and

FIG. 9 illustrates an example of the displayed results of a player's final accusation.

### DETAILED DESCRIPTION OF PREFERED EMBODIMENTS

In a described embodiment, the invention provides an interaction between a multimedia system and a multiplayer boardgame. The players interact with the multimedia system through an input device in response to selections made through the display. In addition to a standard input device such as a remote, an interference interface, herein using the lens associated with a Red Reader interface reader 100, provides a unique type of interaction between the player and the game. The multimedia system generates concealed images on the display which only an interference interface is able to reveal. This allows the game program to send a number encoded in the concealed image to only the player with the interference interface at the time the image is displayed. Thus the interface allows a selected player to receive one or more messages from the game system, e.g., via a number that may correspond to a message from a game booklet or the like. Additionally, the interference interface also facilitates the player sending a message to the game by moving an encoded image under one of many selections available on the display. The multimedia system receives the inputted message, processes, and displays an output in response.

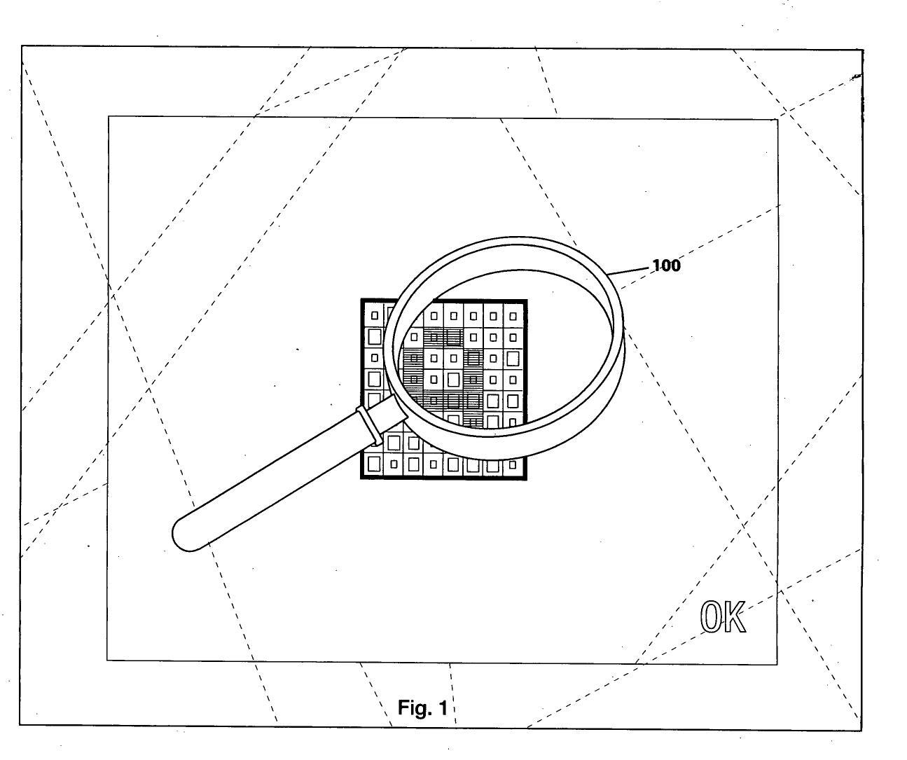

In a present described embodiment of the present invention is to be implemented into the CLUE™ boardgame. The game contains most of the original elements of the original CLUE boardgame but would now include a DVD disc. Players interact with the DVD disc through the DVD remote and a TV. The DVD disc adds extra multimedia elements to the traditional game of CLUE. The multimedia elements include receiving hints from the DVD disc, entering a final accusation using an input device such as the DVD remote, taking a secret passage, looking at an item card, and responding to a challenge from the inspector. The game includes a reader used by the player to receive a concealed image from the screen. The reader, called the “Red Reader”, is a filtered lens used to view a concealed image tailored to be viewed by the filtered lens. FIG. 1 illustrates the Red Reader interface reader 100. The Red Reader interface 100 is used to either allow the player to receive a confidential message by referencing a concealed image in an index or to input private information by moving a concealed image underneath a selection using the DVD remote. The players begin the game by inserting the DVD disc into a DVD player.

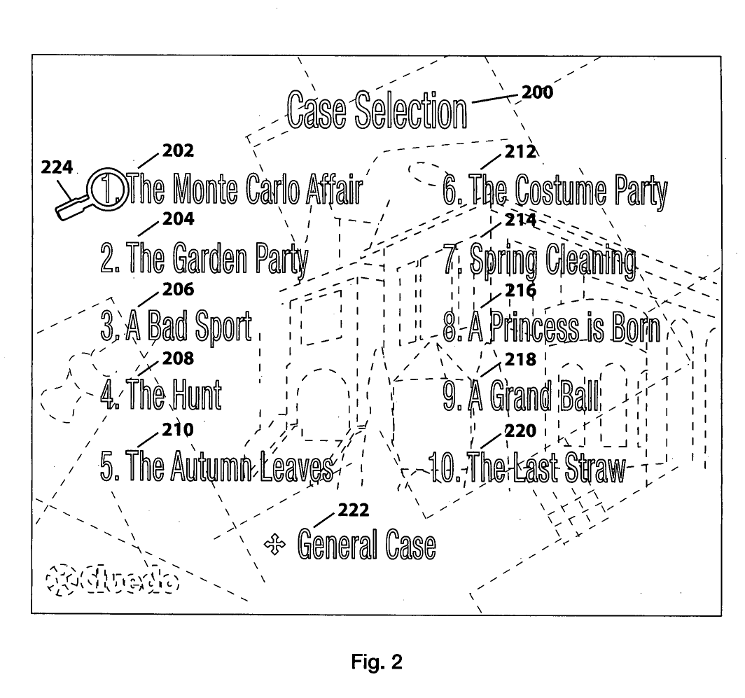

Once the DVD disc is inserted into the player, the DVD player will display the case selection menu. FIG. 2 is an example of case selection menu 200. From this screen, the players may select one of ten predetermined cases 202, 204, 206, 208, 210, 212, 214, 216, 218, 220 or a defined general case 222. The players make their selection by using the DVD remote as an input device to position the magnifying glass indicator 224 next to their selection. The Red Reader 100 of the present described embodiment is used with the ten (10) predetermined cases and is not used with any of the general cases. The DVD player facilitates interactive image display utilizing compact discs, CD, DVD or the like, encoded with video content and format information for video programming to create applications combined with high quality video images. The DVD player and the disc media provide format information encoded on a plurality of tracks on the disc.

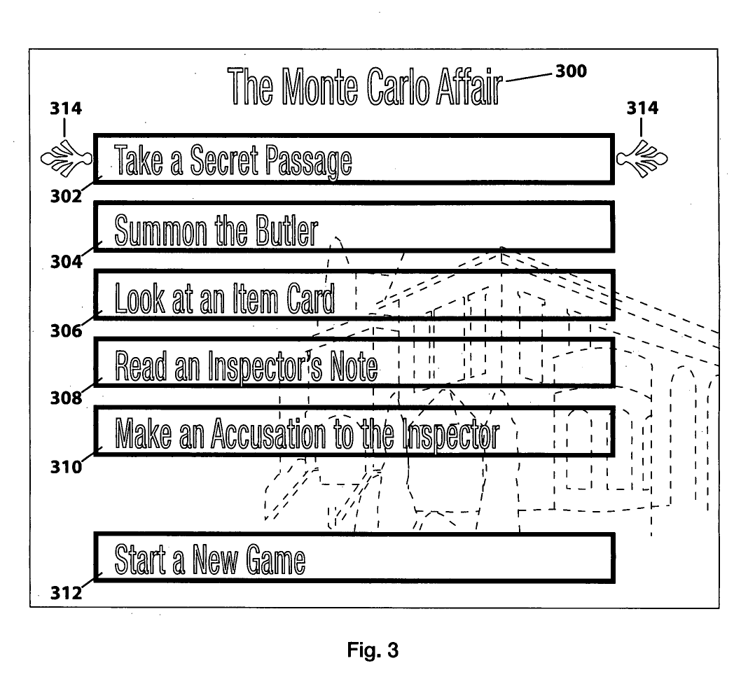

After the player selects one of the predetermined cases, the DVD player will display an animated sequence instructing the players on how to setup the game for play. The game then begins and the main menu for the case is displayed. As shown in FIG. 3, the case main menu screen displays the name of the case at the top 300 and a number of options a player is able to make. The player has the option to take a secret passage 302, summon the butler 304, look at an item card 306, read an inspector's note, make an accusation to the inspector 310 or to start a new game 312. Not all the options are available at the beginning of the game and become available as the game progresses. The player makes his selection by using the DVD remote as an input device to position the on screen indicator 314 next to his selection. The Red Reader interface 100 is used to facilitate the options to read an inspector's note 308 or to make an accusation to the inspector 310.

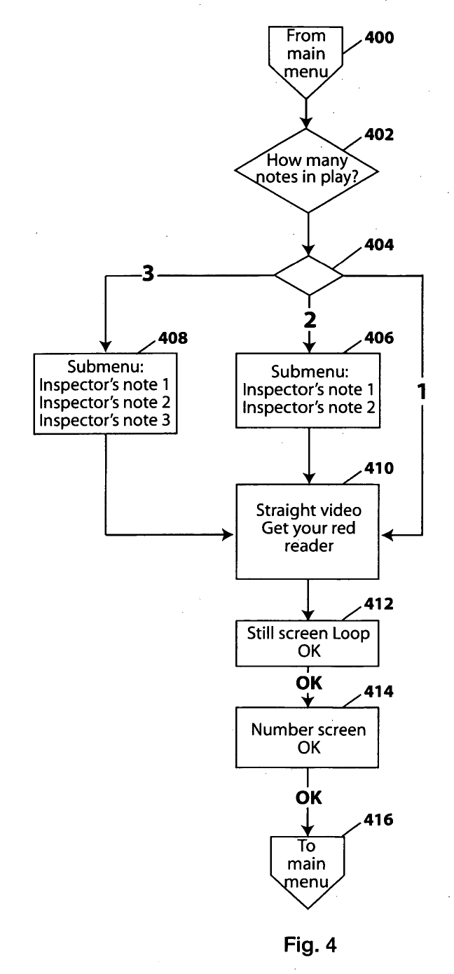

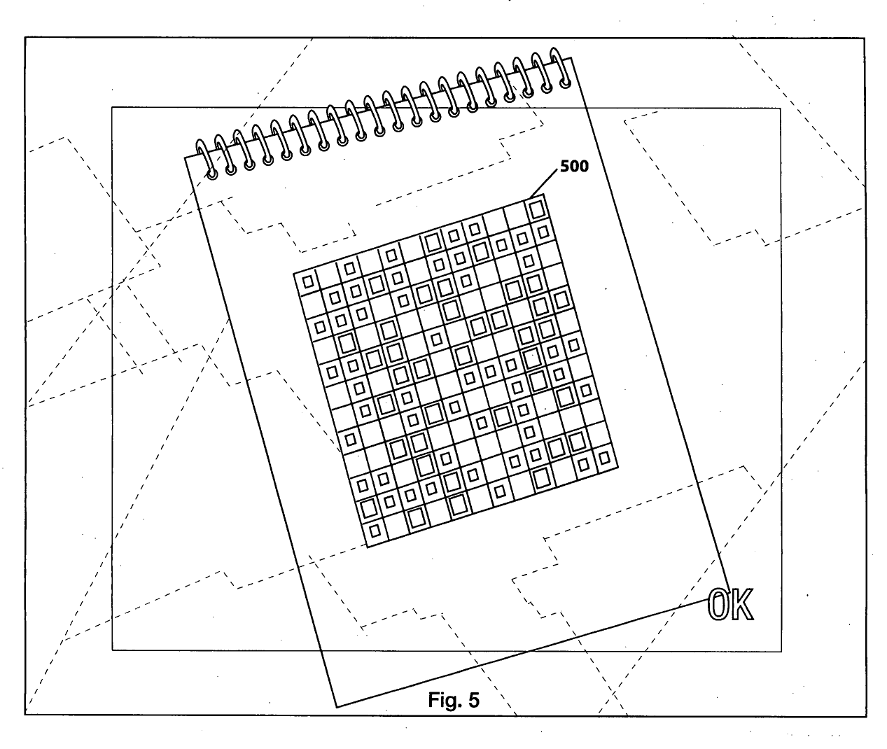

If the player selects the option to read an inspector's note 308, the DVD player follows the programming flow as illustrated in FIG. 4. The programming flow begins with an inquiry into how many notes are in play 402. The query is based on the events that have already happened in the mystery. Therefore, the result of this inquiry will be different for each of the predetermined cases. All of the cases have either two or three notes available. If only one note is available to read, the DVD player selects the note for display to the player 404. If more than one note is available, the DVD player displays a menu that allows the player to select which note to view 406, 408. After a note has been chosen for viewing (either by the participant player or the DVD player), the DVD player displays an animated sequence instructing the player to get the Red Reader 410. The DVD player then displays a still screen image and plays an audio track asking the player if he or she is ready to view the instructor's note 412. After the player “OK” from the still screen, the DVD then displays a concealed number on the screen 414. FIG. 5 is an example of the displayed concealed number screen. The screen contains a concealed number 500 against a background of a notebook 502. The concealed number is only viewable to the player with the Red Reader interface 100 and is not viewable to the other players. The concealed number corresponds to a note located in the instruction manual Appendix, herein the Inspector's Notebook. The note is a hint to the player to help him solve the case. The player may view the concealed note display screen as long as he wishes. The player then selects “OK” from the screen and the game returns back the case main menu 416.

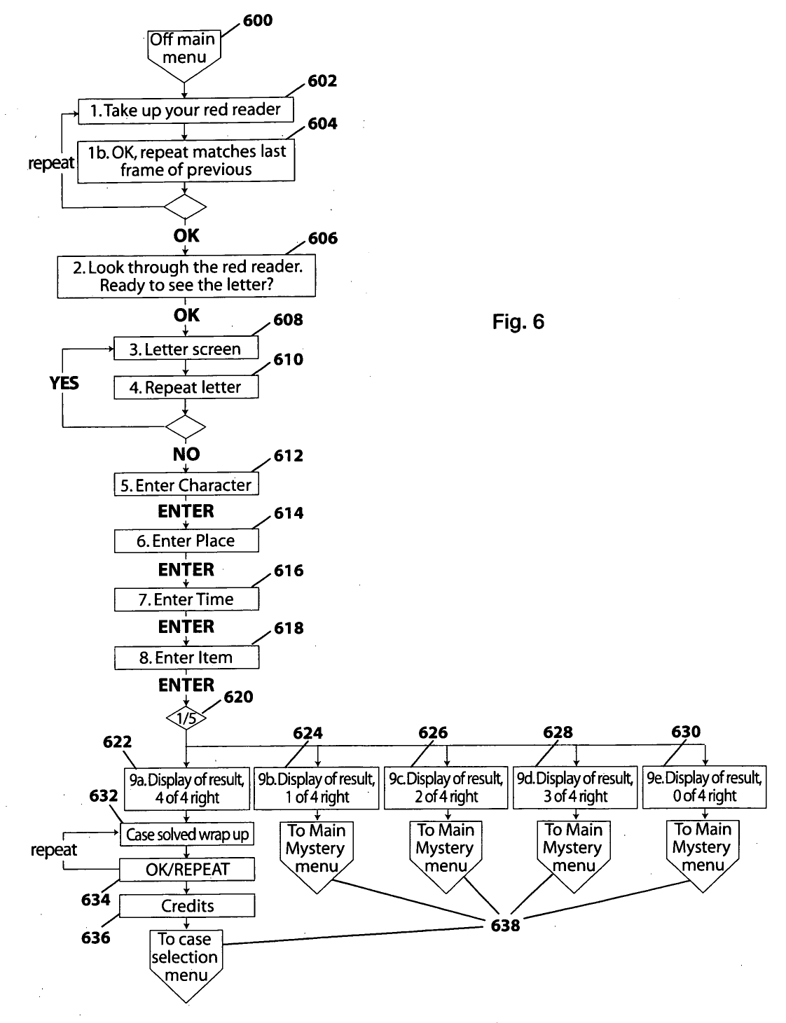

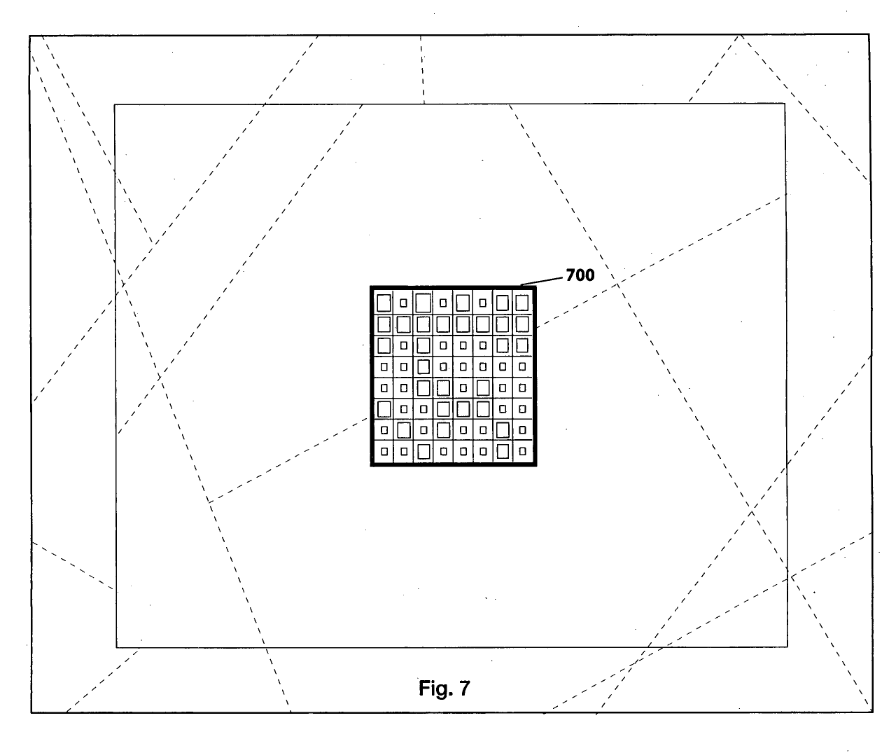

If, from the case main menu, the player selects the option to make an accusation to the inspector 310, the DVD player then follows the programming flow as illustrated in FIG. 6. The DVD player displays an image and plays an audio track instructing the player to get the Red Reader 602. The DVD player then waits for the player to select “OK” from the screen 604. The DVD player then displays a concealed letter on the screen 608. The concealed letter is only viewable to player with the Red Reader interface and is not viewable to the other players. FIG. 7 is an example of the displayed concealed letter screen. The screen contains a concealed letter 700. There are five different concealed letters that the DVD player can choose from. The DVD players selects the concealed letter generated by random or otherwise, however the concealed letter will not be repeated until all five letters have been used. The DVD player then waits for the player to select “OK” from the screen before moving on 610. This concealed letter will be used by the player to select a character, place, time, and item for his final accusation.

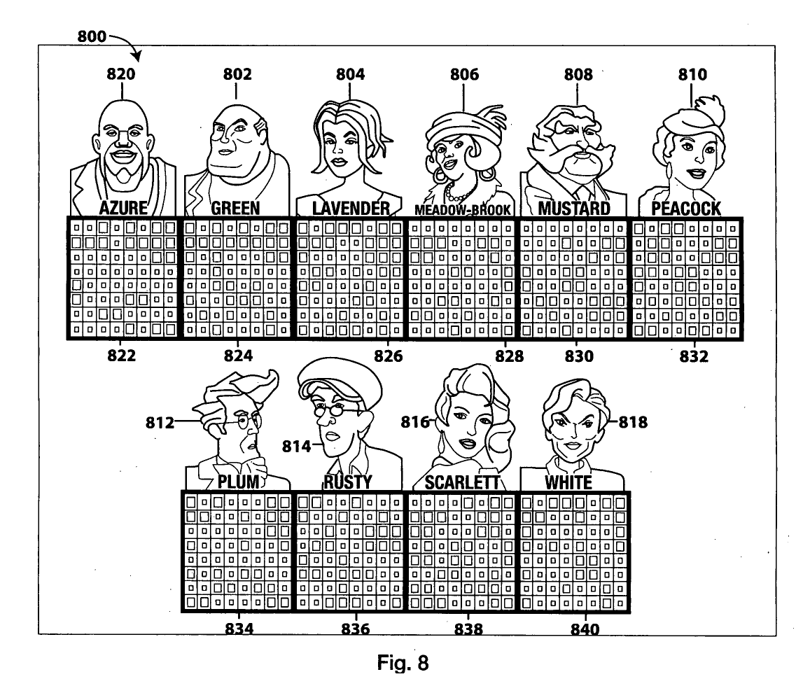

The DVD player then displays the image screen used for inputting a character selection for the final accusation 612. The image screen contains an image of the all the characters in the game and a concealed letter underneath each of the characters. The player uses the Red Reader interface to view these concealed letters and using the DVD remote places the concealed letter given to him under the character he believes committed the crime 612. FIG. 8 is an example of the character selection screen 800. The selection screen displays a picture from the art database of each of the characters within the game 802, 804, 806, 808, 810, 812, 814, 816, 818, 820 and a concealed letter 822, 824, 826, 828, 830, 832, 834, 836, 838, 840 for each of the characters below their respective pictures.

The DVD player repeats the above selection process for the player to enter his selection for place 614, time 616, and item 618.

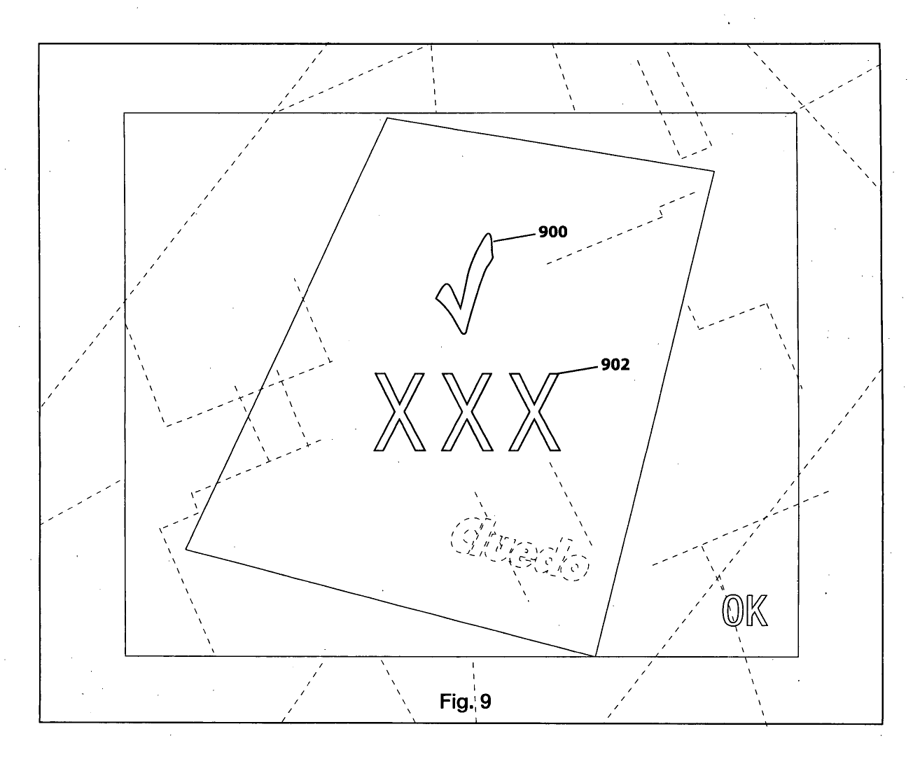

The DVD player then analyzes the player's selections and displays one of five results based on the player's choices 620. The displayed screen is based on the number of selections the player answered correctly, i.e. if four of four correct display 622. If the player answered one of the four selections correctly, a particular image is displayed 624. Likewise, the DVD player displays a particular image for the player answering two 626, three 628, or no 630 correct selections. After displaying the image the DVD player returns to the case main menu 638. FIG. 9 is an example of a results screen based on the player's selections. The results screen contains two rows of either a check 900 or an “X” 902 to indicate the number of selections a player had correct or incorrect. FIG. 9 illustrates the scenario in which a player had one selection correct, as indicated by the sole check 900, and three selections incorrect, as indicated by the three “X”s 902. However, if the player answered all 4 selections correctly, the DVD player displays an animated sequence informing the players that the case has been solved 632. The DVD player asks the players if they would like to repeat the video 634 and if not displays the game credits 636 and returns to the case selection menu 638.

It should be appreciated that a wide range of changes and modifications may be made to the embodiments of the invention as described herein. Thus, it is intended that the foregoing detailed description be regarded as illustrative rather than limiting and that the following claims, including all equivalents, are intended to define the scope of the invention.

What is claimed is:

1. An interference interface comprising:
a multimedia system;
a display for displaying a concealed image generated by the multimedia system;
a reader for viewing the concealed image generated by the multimedia system on the display allowing the user to receive a message by viewing the concealed image through said reader; and
an input device for transmitting an input selection from a user to the multimedia system.

2. An interference interface as recited in claim 1, wherein the multimedia system processes the input selection responsive to the input device and the concealed image being displayed on the display allowing the user to provide an input selection to the multimedia display.

3. An interference interface as recited in claim 1, wherein the reader comprises a colored translucent filtering element.

4. An interference interface as recited in claim 1, wherein the reader comprises a handheld lens.

5. An interference interface as recited in claim 1, wherein the concealed image generated is for transmitting a message comprising an image that is viewable only through the reader for reading the concealed image from a display for receiving a message and unrecognizable to players without the reader for reading a concealed image from the display for receiving a message.

6. An interference interface as recited in claim 1, wherein the concealed image generated is for transmitting a message comprising an image that is viewable only through the reader for reading the concealed image from a display for inputting a value and unrecognizable to players without the reader for reading a concealed image from the display for inputting the value.

7. An interference interface as recited in claim 1, wherein a multimedia system for generating a concealed image comprises a DVD player or a computer.

8. An interference interface as recited in claim 1, wherein a display comprises a television or a computer.

9. An interference interface as recited in claim 1, wherein a display comprises an animated sequence and still images generated by the multimedia system.

10. An interference interface as recited in claim 1, wherein an input device comprises a DVD, television, or computer remote.

11. A method for an interaction between a player and a game using an interference interface, the method comprising:
receiving private information from the game to the player through the interference interface; and
inputting private information from the player to the game through the interference interface.

12. A method for an interaction between a player and a game as recited in claim 11, wherein receiving private information from the game to the player through an interference interface comprises a character concealed in an image.

13. A method for an interaction between a player and a game as recited in claim 11, wherein receiving private information from the game to the player through an interference interface comprises a notebook containing charactered phrases.

14. A method for an interaction between a player and a game as recited in claim 11, wherein receiving private information from the game to the player though an interference interface comprises a handheld lens for reading a concealed image from a display for receiving a character.

15. A method for an interaction between a player and a game as recited in claim 11, wherein receiving private information from the game to the player through an interference interface comprises a comparison between a character read from a concealed image and a charactered phrase in a notebook.

16. A method for an interaction between a player and a game as recited in claim 11, wherein inputting private information from the player to the game through an interference interface comprises a character concealed in an image.

17. A method for an interaction between a player and a game as recited in claim 11, wherein inputting private information from the player to the game through an interference interface comprises a handheld lens for reading a concealed image from a display for inputting a value.

18. A method for an interaction between a player and a game as recited in claim 11, wherein inputting private information from the player to the game through an interference interface comprises an art database containing images to be displayed on the display.

19. A method for an interaction between a player and a game as recited in claim 11, wherein inputting private information from the player to the game through an interference interface comprises an input device able to transmit a player's selection.

20. A method for an interaction between a player and a game as recited in claim 11, wherein inputting private information from the player to the game through an interference interface comprises a player placing the concealed character visible to the player by a handheld lens for reading a concealed image from a display for inputting a value via an input device under an image corresponding to the player's selection.

21. A computer readable media operable with a computer, television, or DVD player comprising:
a display routine for displaying a concealed image on a display viewable by a reader; and
an input interface routine for receiving an input selection responsive to an input device and the concealed image being displayed on the display allowing a user to provide an input selection to the computer, television, or DVD player.

22. A computer readable media as recited in claim 21, wherein the concealed image is displayed for transmitting a message comprised of an image that is viewable using an interference interface for reading the concealed image from the display for receiving a message unrecognizable to other participant players.

23. A computer readable media as recited in claim 21, wherein the concealed image is displayed for transmitting a message comprises of an image that is viewable using an interference interface for reading the concealed image from a display for inputting a value unrecognizable to other participant players.
